(19) United States
(12) Patent Application Publication
(10) Pub. No.: US 2021/0026373 A1
(43) Pub. Date: Jan. 28, 2021

(54) VEHICLE PLATOONING USING SURFACE-PENETRATING RADAR SYSTEMS

(71) Applicants: Daniel Jamison, Derry, NH (US); Byron Stanley, Newton, MA (US)

(72) Inventors: Daniel Jamison, Derry, NH (US); Byron Stanley, Newton, MA (US)

(21) Appl. No.: 16/933,395

(22) Filed: Jul. 20, 2020

Related U.S. Application Data
(60) Provisional application No. 62/876,969, filed on Jul. 22, 2019.

(51) Int. Cl. G05D 1/02; G01C 21/34; G01C 21/00; G08G 1/00; H04W 4/46; H04W 4/024; H04W 4/02; G01S 13/88; G01S 13/931

(52) U.S. Cl. CPC G05D 1/0295; G01S 2013/93271; G01C 21/3815; G08G 1/22; G01C 21/3841; G05D 1/0223; G08G 1/20; G05D 1/0257; G05D 1/0276; H04W 4/46; H04W 4/024; H04W 4/027; G01S 13/885; G01S 13/931; G01S 2013/9325; G01C 21/3407

(57) ABSTRACT

One or more vehicles in a platoon may be operated autonomously using a surface-penetrating radar (SPR) system implemented in the lead vehicle. SPR signals obtained by the system may be converted to one or more images (or scans) that provide information about the ground surface and/or other surfaces around the vehicle within a detection range of the SPR system. Based on the obtained SPR signals, the lead vehicle may create a real-time map including the SPR information and/or localize the real-time SPR information to an existing map. This real-time SPR map information may then be transmitted from the lead vehicle to succeeding vehicles in the platoon in a pass-it-down fashion for localizing the succeeding vehicles behind the lead vehicle.

### CROSS-REFERENCE TO RELATED APPLICATION

This application claims priority to and the benefit of, and incorporates herein by reference in its entirety, U.S. Provisional Patent Application No. 62/876,969, filed on Jul. 22, 2019.

### FIELD OF THE INVENTION

The present invention relates, generally, to vehicle platooning and, more particularly, to vehicle platooning using surface-penetrating radar (SPR) systems.

### BACKGROUND

Various countries have recently set a goal of reducing greenhouse gas emissions to fight climate change. Currently, heavy-duty vehicles are responsible for 27% of road transport CO₂ emissions in Europe and almost 5% of EU greenhouse gas emissions (2016 data). Since 1990, heavy-duty vehicle emissions have increased by 25%—mainly as a result of an increase in road freight traffic—and, in the absence of new policies, they are projected to further increase. Thus, an emphasis has been placed on reducing fuel consumption of, inter alia, heavy-duty vehicles to reach emissions-reduction goals, save on fuel costs, reduce the amount of truck-related deaths due to human error, save trucking companies money on labor costs, and mitigate the effect of the current shortage of truck drivers.

One way to reduce vehicle emissions is to operate several vehicles in a chain formation, also known as “platooning” or operating vehicles as a fleet or convoy. Convoyed vehicles may follow each other closely, thereby reducing aerodynamic drag and lowering greenhouse gas emissions as well as fuel consumption. Conventional techniques, such as adaptive cruise control, may be applied in vehicle platooning. Typically, these techniques employ one or more sensors or cameras in each vehicle for detecting information about the vehicles ahead, and based on the detected information, brake or accelerate. While the conventional techniques may provide help to the drivers of the vehicles in a chain formation, they do not provide full autonomy—i.e., they do not allow the vehicles to operate themselves without drivers.

In addition, in conventional vehicle platooning, the sensors employed in the vehicles may provide the detected information as inputs to the following vehicles so that the succeeding vehicles can closely follow the vehicles ahead and facilitate braking, turning, etc. But when there are too many vehicles in the platoon or when there is too great a distance between the consecutive vehicles, a lateral error on the sensing data built up along the vehicle platoon may be significant. Typically, if the vehicles following the lead vehicle are large (e.g., trucks), the allowed margin of the lateral error may be limited (e.g., ˜1 foot), thus the cumulative error may cause safety concerns.

Accordingly, there is a need for approaches that eliminate the need for drivers in at least some of the vehicles traveling as a fleet (or in a platooning fashion) and/or reduce a cumulative error on the sensing information along the vehicle platoon.

### SUMMARY

Embodiments of the present invention enable full autonomy of at least some vehicles (e.g., heavy-duty vehicles) operated in a platooning fashion. In one embodiment, an SPR system is implemented in a lead vehicle of the platoon and obtains SPR signals; the obtained SPR signals may be converted to one or more images (or scans) characterizing the ground surface and/or other surfaces around the vehicle within a detection range of the SPR system. Based on the obtained SPR signals, the lead vehicle may create a real-time map including the SPR information and/or localize the real-time SPR information to an existing map. This real-time SPR map information may then be transmitted from the lead vehicle to succeeding vehicles in the platoon in a pass-it-down fashion for localizing the succeeding vehicles behind the lead vehicle. As used herein, the term “pass-it-down fashion” refers to a situation where the lead vehicle records the real-time map and the following vehicles track the map, or an alternative situation where each vehicle records its own map and then passes it to the next vehicle.

Because the real-time SPR map information propagates back from vehicle to vehicle along the line of vehicles, this approach effectively creates a digital monorail. The vehicles behind the lead vehicle can then be operated based on the SPR map information that they receive, thereby eliminating the need for drivers in all (or at least some) of these succeeding vehicles. In addition, because the vehicles following the lead vehicle need not provide individual sensing data to the vehicle(s) behind them, this approach may significantly reduce the cumulative error occurred in conventional vehicle platooning approaches, and/or increase the acceptable separation distance between the vehicles for navigating the vehicle platoon. Further, this approach may eliminate the need for all (or at least some) of the succeeding vehicles to individually correlate or localize to an existing map; this not only reduces the per-vehicle cost of implementation but also avoids accumulated errors resulting from creation of multiple maps by individual vehicles in the platoon when operating the vehicles.

Accordingly, in one aspect, the invention relates to a system for navigating a plurality of vehicles as the vehicles travel in a platoon or a convoy along a path. In various embodiments, the system comprises an SPR system configured for attachment to a lead vehicle of the traveling vehicles for acquiring real-time SPR information associated therewith; and at least one controller configured to generate a navigation map including the acquired real-time SPR information associated with the lead vehicle, cause the generated map to be transmitted from the lead vehicle to other vehicles of the traveling vehicles, and operate the lead vehicle and other vehicles based at least in part on the generated map.

In various embodiments, the SPR system is further configured for attachment to at least one of the other vehicles following the lead vehicle. The controller(s) may be configured to cause the generated map to be transmitted between the vehicles via the SPR systems. The SPR system may be further configured for attachment to at least one of the other vehicles following the lead vehicle for acquiring real-time SPR information associated therewith, where the controller(s) are configured to generate a secondary navigation map including the acquired real-time SPR information associated with one or more of the other vehicles following the lead vehicle.

In some embodiments, the controller(s) are further configured to cause the generated map to be transmitted from the lead vehicle to other vehicles in a sequential fashion. For example, the generated map may be transmitted from the lead vehicle to a first vehicle and from the first vehicle to a second vehicle, where the first vehicle is closest behind the lead vehicle and the second vehicle is closest behind the first vehicle. In various embodiments, the system further includes a plurality of communication modules, each associated with one of the traveling vehicles, for transmitting the generated map in the sequential fashion; or for otherwise transmitting the generated map between or among the traveling vehicles.

The SPR system may comprise or consist of a ground-penetrating radar (GPR) system. The GPR system, in turn, may include a GPR antenna array oriented in parallel to the ground surface.

In some embodiments, the controller is further configured to retrieve an existing map from a navigation system and generate the navigation map by localizing the real-time SPR information to the existing map. Alternatively or in addition, the controller may be configured to determine at least one of steering, orientation, velocity, pose, acceleration or deceleration associated with a corresponding vehicle based at least in part on the generated map and/or relative positions between the plurality of vehicles.

In various embodiments, the system further includes at least one vehicle control module, coupled to the at least one controller, for controlling operation of each vehicle based at least in part on the determined steering, orientation, velocity, pose, acceleration and/or deceleration. The controller may be configured to determine a cumulative error associated with a corresponding vehicle or its SPR system.

In another aspect, the invention pertains to a method of operating a plurality of vehicles as the vehicles travel in a platoon along a path. In various embodiments, the method comprises causing a lead vehicle in the traveling vehicles to acquire real-time SPR information associated therewith; generating a map including the real-time SPR information; transmitting the generated map from the lead vehicle to other vehicles of the traveling vehicles; and operating the lead vehicle and other vehicles based at least in part on the generated map.

The generated map may include information about a surface condition and/or a driving condition associated with the path. In some embodiments, the method further comprises the step of computationally generating a secondary navigation map including the acquired real-time SPR information associated with at least one of the other vehicles following the lead vehicle. The generated map may be transmitted from the lead vehicle to other vehicles in a sequential fashion. For example, the generated map may be transmitted from the lead vehicle to a first vehicle and from the first vehicle to a second vehicle, where the first vehicle is closest behind the lead vehicle and the second vehicle is closest behind the first vehicle.

In some embodiments, the method further comprises the step of retrieving an existing map from a navigation system, where the step of generating the map comprises localizing the real-time SPR information to the existing map. The method may include the step of determining at least one of steering, orientation, velocity, pose, acceleration or deceleration associated with each vehicle based at least in part on the generated map and/or relative positions between the plurality of vehicles. In some embodiments, the method further comprises the step of controlling operation of each vehicle based at least in part on the determined steering, orientation, velocity, pose, acceleration and/or deceleration.

### BRIEF DESCRIPTION OF THE DRAWINGS

The foregoing and the following detailed description will be more readily understood when taken in conjunction with the drawings, in which:

FIG. 1A schematically depicts a vehicle platoon subject to control in accordance with embodiments of the invention.

FIG. 1B schematically illustrates an exemplary traveling vehicle including a terrain monitoring system in accordance with embodiments of the invention.

FIG. 1C schematically illustrates an alternative configuration in which the antenna of the terrain monitoring system is closer to or in contact with the surface of the road.

FIG. 2A schematically depicts an exemplary terrain monitoring system for lead vehicles in accordance with embodiments of the invention.

FIG. 2B schematically depicts a navigation system for trailing vehicles in accordance with embodiments of the invention.

### DETAILED DESCRIPTION

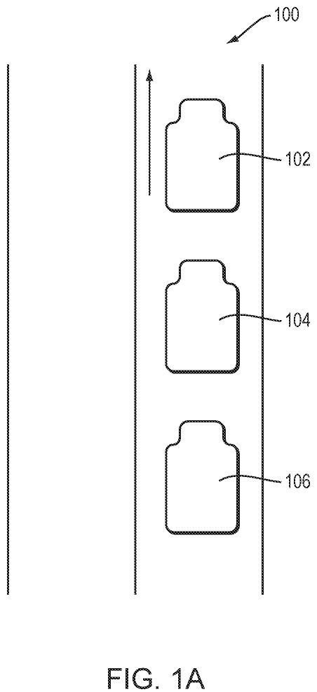

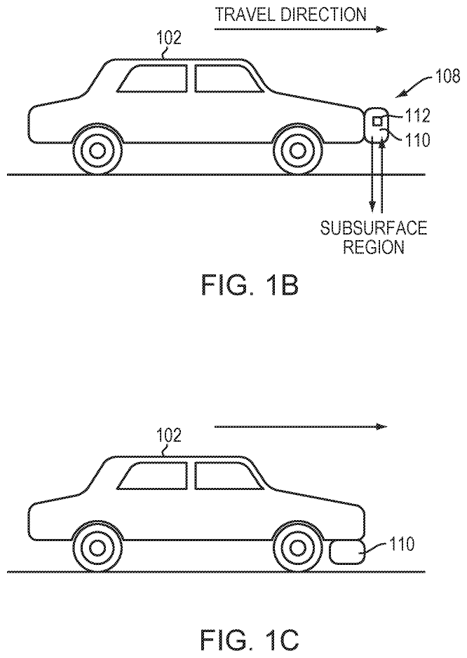

Refer first to FIG. 1A, which depicts an exemplary vehicle platoon 100 having one lead vehicle 102 and one or more following vehicles 104, 106 traveling on a predefined trip path in accordance with various embodiments. As shown in FIG. 1B, the lead vehicle 102 may be provided with an SPR system 108 for navigation and vehicle localization. In various embodiments, the SPR system 108 includes a ground-penetrating radar (GPR) antenna array 110 fixed underneath and/or to the front (or any suitable portion) of the lead vehicle 102. The GPR antenna array 110 is generally oriented parallel to the ground surface and may extend perpendicular to the direction of travel. In an alternative configuration, the GPR antenna array 110 is closer to or in contact with the surface of the road (FIG. 1C). In one embodiment, the GPR antenna array 110 includes a linear configuration of spatially-invariant antenna elements for transmitting GPR signals to the road; the GPR signals may propagate through the road surface into the subsurface region and be reflected in an upward direction. The reflected GPR signals can be detected by the receiving antenna elements in the GPR antenna array 110. In various embodiments, the detected GPR signals are then processed and analyzed to generate one or more SPR images (e.g., GPR images) of the subsurface region along the track of the lead vehicle 102. In one embodiment, the SPR images may be processed to extract features used to map and localize the lead vehicle 102 and/or the following vehicles; transmitting only these features may reduce the overall amount of navigation data transferred between vehicles, thereby reducing the latency and improving system stability. If the SPR antenna array 110 is not in contact with the surface, the strongest return signal received may be the reflection caused by the road surface. Thus, the SPR images may include surface data, i.e., data for the interface of the subsurface region with air or the local environment.

In some embodiments, the SPR images are compared to SPR reference images that were previously acquired and stored for subsurface regions that at least partially overlap the subsurface regions for the defined trip path. The image comparison may be a registration process based on, for example, correlation; see, e.g., U.S. Pat. No. 8,786,485 and U.S. Patent Publication No. 2013/0050008, the entire disclosures of which are incorporated by reference herein. The path and/or location of the lead vehicle 102 can be determined based on the comparison. In one embodiment, the path data is used to create a real-time map including the SPR information for navigating the lead vehicle 102. For example, based on the real-time SPR map information, the velocity, acceleration, orientation, angular velocity and/or angular acceleration of the lead vehicle 102 may be continuously controlled via a controller 112 so as to maintain travel of the lead vehicle 102 along the predefined trip path.

In some embodiments, the path data for the lead vehicle is used in combination with the data provided by one or more other sensors or navigation systems, such as an inertial navigation system (INS), a global positioning system (GPS), a sound navigation and ranging (SONAR) system, a LIDAR system, a camera, an inertial measurement unit (IMU) and/or an auxiliary radar system, to guide the lead vehicle 102. For example, the controller 112 may localize the real-time SPR information to an existing map generated by the GPS. Again, based on the combination of the existing map and the obtained real-time SPR information, the lead vehicle 102 may be continuously operated so as to travel along the predefined trip path. Approaches for utilizing the SPR system for vehicle navigation and localization are described in, for example, U.S. Pat. No. 8,949,024, the entire disclosure of which is incorporated by reference herein. In addition, for ease of reference, the real-time map including the SPR information and the combination of the existing map and real-time SPR information created based on the path data are referred to herein as the real-time SPR map information.

In various embodiments, the real-time SPR map information is transmitted from the lead vehicle 102 to other vehicles 104, 106 in the platoon 100 in a pass-it-down fashion for localizing the vehicles behind the lead vehicle 102. For example, the lead vehicle 102 may transmit the real-time SPR map information to the closest succeeding vehicle 104, which then transmits the received real-time SPR map information to the closest succeeding vehicle 106. The vehicles 104, 106 behind the lead vehicle 102 can then be operated based on the received SPR map information without generating their own maps. This approach may thus allow fully or partially autonomous operation of at least some of the vehicles (e.g., the succeeding vehicles 104, 106) in the platoon 100 without the need for drivers therein. In addition, because this approach eliminates the need for all vehicles in the platoon 100 to individually correlate to an existing map, it may advantageously avoid accumulated errors resulting from creation of multiple maps by the individual vehicles. Cost is also reduced, since SPR systems need not be implemented in all vehicles of the platoon 100.

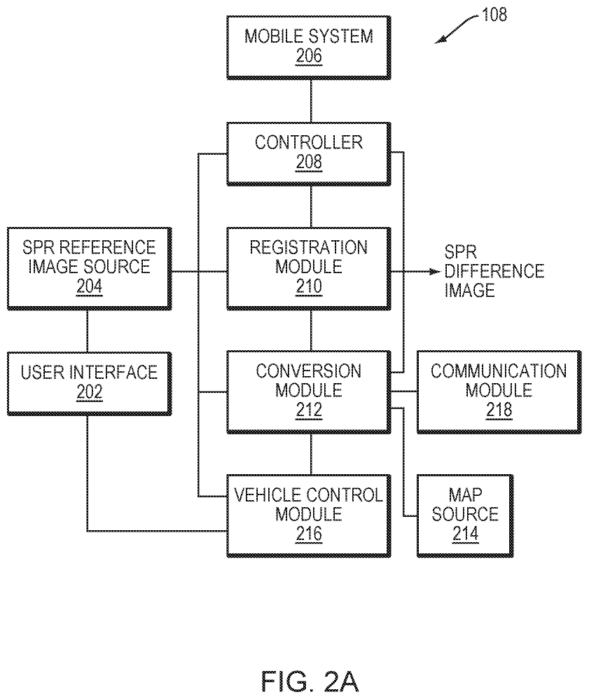

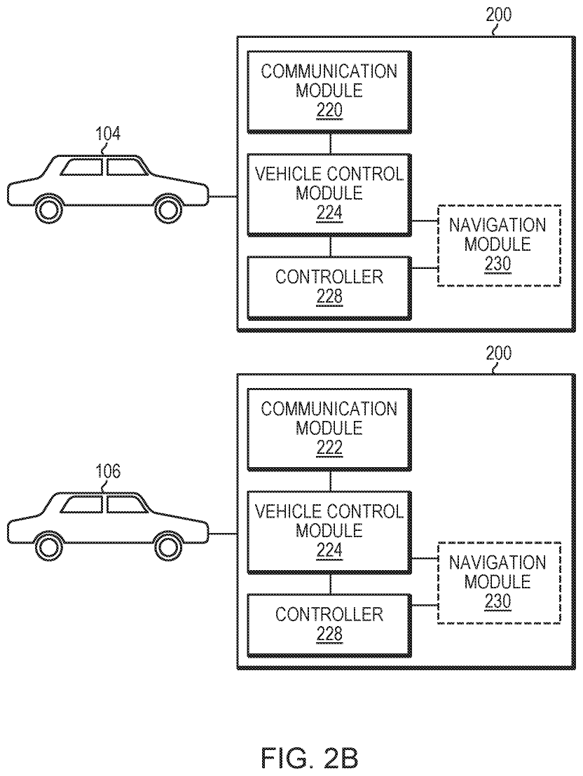

FIGS. 2A and 2B depict, respectively, an exemplary SPR system 108 implemented in the lead vehicle 102 and a navigation system 200 implemented in the succeeding vehicles 104, 106 in a vehicle platoon 100; this arrangement facilitates autonomous operation of at least some of the succeeding vehicles in accordance herewith. As shown in FIG. 2A, the SPR system 108 may include a user interface 202 through which a user can enter data to define the trip path, to obtain the trip path from a navigation application or server, or to select a predefined trip path. SPR images are retrieved from an SPR reference image source 204 according to the trip path.

The SPR system 108 also includes a mobile SPR system (“Mobile System”) 206 having an SPR antenna array 110. The transmit operation of the mobile SPR system 206 is controlled by a controller (e.g., a processor) 208 that also receives the return SPR signals detected by the SPR antenna array 110. The controller 208 generates SPR images of the subsurface region below the road surface underneath the SPR antenna array 110 in accordance, for example, with the '024 patent. The SPR image includes features representative of structures and objects within the subsurface region, such as rocks, roots, boulders, pipes, voids and soil layering, and other features indicative of variations in the soil or material properties (e.g., electromagnetic properties) of the soils and other subsurface materials. In various embodiments, a registration module 210 compares the SPR images provided by the controller 208 to the SPR images retrieved from the SPR reference image source 204 to determine a difference, which may correspond to the offset of the vehicle with respect to the closest point on the trip path. In various embodiments, the SPR information (e.g., offset data, or positional error data) determined in the registration process is provided to a conversion module 212 that creates a real-time map based on the obtained and reference SPR images for navigating the lead vehicle 102. For example, the conversion module 212 may generate GPS data corrected for the vehicle positional deviation from the trip path. Alternatively, the conversion module 212 may retrieve an existing map from a map source 214 (e.g., another navigation system, such as one based on GPS), and then localize the real-time SPR information to the existing map. In any case, the real-time map information may be provided to a vehicle control module 216 coupled to the controller 208 for controlling steering, orientation, velocity, pose and acceleration/deceleration of the lead vehicle 202. For example, the vehicle control module 216 may include or cooperate with electrical, mechanical and pneumatic devices in the vehicle to achieve steering and speed control. Semantic labels may be applied to the map. The map may also allow a vehicle to deviate from the path taken by the vehicle ahead of it in order to better navigate the terrain.

The control module 216 may be configured to detect and measure cumulative error, i.e., as an instantaneous value, a time-averaged value or in terms of its change over time. This facilitates measurement of vehicle or sensor (e.g., SPR) drifting tendencies, which may be subject to correction, used as a metric in a feedback-control configuration, or used as a diagnostic tool for the vehicle or sensor suite.

In various embodiments, the SPR system 108 includes a communication module 218 facilitating communication between the lead vehicle 102 and communication modules 220, 222 deployed in other vehicles 104, 106 (FIG. 2B). For example, the lead vehicle 102 may transmit the generated real-time SPR map information (e.g., representing the path of the lead vehicle) via the communication module 218 to the communication module 220 in the closest succeeding vehicle 104, which then transmits the received real-time SPR map information via its associated communication module 220 to the communication module 222 in the succeeding vehicle 106. Referring to FIG. 2B, each succeeding vehicle may include a vehicle control module 224 and a controller 228. The real-time SPR map information received by the communication module in each succeeding vehicle may be provided to its associated vehicle control module. Based on the received real-time SPR map information, the controller and vehicle control module may autonomously operate the steering, orientation, velocity, pose and/or acceleration/deceleration of each succeeding vehicle. Again, the vehicle control module 224 may include or cooperate with, for example, electrical, mechanical and pneumatic devices in each succeeding vehicle to achieve steering and speed control. For example, if a vehicle control module 224 receives the path of the lead vehicle 102, it can readily compute its own location based on the maintained platoon distance therefrom. Additionally or alternatively, the following vehicles may simply maximize overlap with the map and follow the original route as closely as possible.

Optionally, each succeeding vehicle may include a navigation module 230 for acquiring GPS data associated with the vehicle. The controller and vehicle control module may then operate the vehicle based on the real-time SPR map information and GPS data. Additionally or alternatively, the controller 208 and the vehicle control module 224 may operate the vehicle based on other information, such as information about steering, braking, wheel odometry, etc. provided by any suitable sensors (e.g., LIDAR, cameras, etc.).

In various embodiments, the lead vehicle 102 includes more robust hardware and software for mapping. For example, the SPR system 108 in the lead vehicle 102 may include a larger antenna radar and array with more elements, higher processing ability, and more data storage, whereas the following vehicles may include a more cost-effective system with, for example, a smaller radar and array with fewer elements, as well as reduced processing capability and data storage. In addition, other key information (such as a confidence value, heading, acceleration, etc.) obtained by the GPR sensor or inferred from data provided thereby may be passed along in sequence to subsequent vehicles to update them regarding the current state, which the control module 216 of each vehicle analyzes to determine whether an action (e.g., a change of speed or bearing) is needed. That is, the lead vehicle 102 periodically transmits state information that propagates through the platoon, and each succeeding vehicle assesses the current state against previous states to make an independent control decision. State information may include one or more of steering, orientation, velocity (speed and bearing), pose, acceleration or deceleration, sensor readings, warnings, communication status, etc. to enable each vehicle to select an action in accordance with a control program implemented in its controller 228.

Further, in addition to one-dimensional (1D) platooning, the approaches described above may be implemented in two-dimensional (2D) platooning as well. As used herein, the term 1D platooning refers to a configuration in which all vehicles in the platoon are in a single lane, one after another (essentially a line of vehicles), whereas in 2D platooning, the vehicles in the platoon are spread out across multiple lanes. 2D platooning vehicles may form a dense or sparse rectangular “matrix” or complex configuration as determined by a suitable vehicle arrangement profile that may be programmed in each vehicle's controller. With the lead vehicle (manned or unmanned) creating/localizing to a GPR map, the following vehicle may need to know only a fixed offset from that vehicle or an adjacent vehicle. This offset can be determined from an existing GPR map or any other sensors, or by communication among vehicles. This approach may be advantageously employed in snow plowing, construction, mapping and other applications on- and off-road.

The communication modules 218-222 may include a conventional component (e.g., a network interface or transceiver) designed to provide wired and/or wireless communications therebetween. In one embodiment, the communication modules 218-222 directly communicate with each other. Additionally or alternatively, the communication modules 218-222 may indirectly communicate with each other via infrastructure, such as the public telecommunications infrastructure, a roadside unit, a remote platooning coordination system, a mobile communication server, etc. The wireless communication may be performed by means of a wireless communication system with WiFi, Bluetooth, infrared (IR) communication, a phone network, such as general packet radio service (GPRS), 3G, 4G, 5G, Enhanced Data GSM Environment (EDGE), or other non-RF communication systems such as an optical system, etc. In addition, the wireless communication may be performed using any suitable modulation schemes, such as AM, FM, FSK, PSK, ASK, QAM, etc.

In addition, the controllers 208, 228 implemented in the lead vehicle and/or succeeding vehicles of the platooning vehicles may include one or more modules implemented in hardware, software, or a combination of both. For embodiments in which the functions are provided as one or more software programs, the programs may be written in any of a number of high level languages such as PYTHON, FORTRAN, PASCAL, JAVA, C, C++, C#, BASIC, various scripting languages, and/or HTML. Additionally, the software can be implemented in an assembly language directed to the microprocessor resident on a target computer; for example, the software may be implemented in Intel 80x86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A system for navigating a plurality of vehicles as the vehicles travel in a platoon or a convoy along a path, the system comprising:
a surface-penetrating radar (SPR) system configured for attachment to a lead vehicle of the traveling vehicles for acquiring real-time SPR information associated therewith; and
at least one controller configured to:
generate a navigation map including the acquired real-time SPR information associated with the lead vehicle;
cause the generated map to be transmitted from the lead vehicle to other vehicles of the traveling vehicles; and
operate the lead vehicle and other vehicles based at least in part on the generated map.

2. The system of claim 1, wherein the SPR system is further configured for attachment to at least one of the other vehicles following the lead vehicle, the at least one controller being configured to cause the generated map to be transmitted between the vehicles via the SPR systems.

3. The system of claim 2, wherein the SPR system is further configured for attachment to at least one of the other vehicles following the lead vehicle for acquiring real-time SPR information associated therewith, the at least one controller being configured to generate a secondary navigation map including the acquired real-time SPR information associated with the at least one of the other vehicles following the lead vehicle.

4. The system of claim 1, wherein the at least one controller is further configured to cause the generated map to be transmitted from the lead vehicle to other vehicles in a sequential fashion.

5. The system of claim 4, wherein the generated map is transmitted from the lead vehicle to a first vehicle and from the first vehicle to a second vehicle, the first vehicle being a closest succeeding vehicle to the lead vehicle and the second vehicle being a closest succeeding vehicle to the first vehicle.

6. The system of claim 4, further comprising a plurality of communication modules, each associated with one of the traveling vehicles, for transmitting the generated map in the sequential fashion.

7. The system of claim 4, further comprising a plurality of communication modules, each associated with one of the traveling vehicles, for transmitting the generated map between the traveling vehicles.

8. The system of claim 1, wherein the SPR system comprises a ground-penetrating radar (GPR) system.

9. The system of claim 8, wherein the GPR system comprises a GPR antenna array oriented in parallel to a ground surface.

10. The system of claim 1, wherein the controller is further configured to:
retrieve an existing map from a navigation system; and
generate the navigation map by localizing the real-time SPR information to the existing map.

11. The system of claim 1, wherein the controller is further configured to determine at least one of steering, orientation, velocity, pose, acceleration or deceleration associated with a corresponding vehicle based at least in part on the generated map and/or relative positions between the plurality of vehicles.

12. The system of claim 1, further comprising at least one vehicle control module, coupled to the at least one controller, for controlling operation of each vehicle based at least in part on the determined steering, orientation, velocity, pose, acceleration and/or deceleration.

13. The system of claim 1, wherein the controller is further configured to determine a cumulative error associated with a corresponding vehicle or its SPR system.

14. A method of operating a plurality of vehicles as the vehicles travel in a platoon along a path, the method comprising:
causing a lead vehicle in the traveling vehicles to acquire real-time surface-penetrating radar (SPR) information associated therewith;
generating a map including the real-time SPR information;
transmitting the generated map from the lead vehicle to other vehicles of the traveling vehicles; and
operating the lead vehicle and other vehicles based at least in part on the generated map.

15. The method of claim 14, wherein the generated map comprises information about a surface condition and/or a driving condition associated with the path.

16. The method of claim 14, further comprising the step of computationally generating a secondary navigation map including the acquired real-time SPR information associated with at least one of the other vehicles following the lead vehicle.

17. The method of claim 14, the generated map is transmitted from the lead vehicle to other vehicles in a sequential fashion.

18. The method of claim 17, wherein the generated map is transmitted from the lead vehicle to a first vehicle and from the first vehicle to a second vehicle, the first vehicle being a closest succeeding vehicle to the lead vehicle and the second vehicle being a closest succeeding vehicle to the first vehicle.

19. The method of claim 14, further comprising the step of retrieving an existing map from a navigation system, the step of generating the map comprising localizing the real-time SPR information to the existing map.

20. The method of claim 14, further comprising the step of determining at least one of steering, orientation, velocity, pose, acceleration or deceleration associated with each vehicle based at least in part on the generated map and/or relative positions between the plurality of vehicles.

21. The method of claim 20, further comprising the step of controlling operation of each vehicle based at least in part on the determined steering, orientation, velocity, pose, acceleration and/or deceleration.
